(19) United States
(12) Patent Application Publication
(10) Pub. No.: US 2025/0170541 A1
(43) Pub. Date: May 29, 2025

(54) DEVICE FOR MIXING FIRST COMPONENT WITH SECOND COMPONENT AND METHOD OF MIXING FIRST COMPONENT WITH SECOND COMPONENT

(71) Applicant: medmix Switzerland AG, Haag (CH)

(72) Inventors: Sarah THUTEWOHL, Grabs (CH); STEFAN KOCH, Romanshorn (CH); Nicolas DELIAVAL, Buchs SG (CH)

(21) Appl. No.: 18/843,047

(22) PCT Filed: Feb. 28, 2023
(86) PCT No.: PCT/EP2023/054964

§ 371 Date: Aug. 30, 2024

(30) Foreign Application Priority Data
Mar. 4, 2022 (EP) 22160149.5
Oct. 5, 2022 (EP) 22199869.3

(51) Int. Cl. B01F 35/71; A61C 5/66; B01F 23/50; B01F 35/52; B01F 101/19; B65D 81/32

(52) U.S. Cl. CPC B01F 35/7131; B01F 23/51; B01F 35/522; B01F 35/7161; B65D 81/3211; A61C 5/66; B01F 2101/19

(57) ABSTRACT

A device for mixing a first component with a second component includes a housing forming a first chamber for the first component, a second chamber for the second component, a separation element for separating the first chamber and the second chamber, and an activation element for creating a breakthrough through the separation element. The activation element is integrally formed with the housing and a predetermined breaking area is formed in the housing to create an outlet for withdrawing a mixture of the first component and the second component.

### CROSS-REFERENCE TO RELATED APPLICATION

This application is a U.S National Stage application of International Application No. PCT/EP2023/054964, filed Feb. 28, 2023, which claims priority to European Application No. 22160149.5, filed Mar. 4, 2022 and European Application No. 22199869.3, filed Oct. 5, 2022, the contents of each of which are herby incorporated by reference.

### BACKGROUND

### Technical Field

The present disclosure relates to a device for mixing a first component with a second component, comprising a housing forming a first chamber for the first component, a second chamber for the second component, a separation element for separating the first chamber and the second chamber, and an activation element for creating a breakthrough through the separation element.

### Background Information

Such a device can be used for mixing a powder with a liquid substance. For example, such a device can be used for mixing two components so that the mixture can be used for dental applications.

### SUMMARY

It is an object of the disclosure to provide a device as described above that is simple to manufacture, easy to use and can only be used a single time.

The object is satisfied by a device having the features disclosed herein and in particular wherein the activation element is integrally formed with the housing and wherein a predetermined breaking area is formed in the housing to create an outlet for withdrawing a mixture of the first component and the second component.

By forming the activation element integrally with the housing, the housing and the activation element can be manufactured as one single part. In order to mix the components, a user can create a breakthrough through the separation element via the activation element. When the two components are mixed together, the user can easily create an outlet for withdrawing the mixture from the housing due to the predetermined breaking area, i.e. an area that is meant to serve as an intended breaking point to create an outlet in the housing.

In this connection it should be noted that the term mixing in the context of the present disclosure is to be understood such that it includes a bringing together of two or more substances to bring about a chemical reaction of the two or more components and/or a physical mixing of two or more components using a mixing device such as a mixer or a simple rod.

Embodiments of the device are described in the following disclosure.

The housing and the activation element integrally formed with the housing can for example be produced cost effectively and swiftly in an injection molding process.

According to one aspect, only on breaking the housing at the predetermined breaking area, the mixture can be retrieved from the device.

The separation element can be made from a foil or any other material, that is capable of separating the first and second chamber in a way, that mixture of the two components is not possible while the separation element is intact. On the other hand, the separation element is configured to be breakable by the activation element.

According to one aspect, the predetermined breaking area extends around at least a majority of a circumference of the housing. In particular, the breaking area can extend completely around circumference of the housing. The predetermined breaking area can be formed by a tapering of the cross section of the housing.

The predetermined breaking area can be arranged so that the device is intentionally breakable into two separate parts. The first part of the two parts can form the first chamber and the second part of the two parts can form the second chamber and the activation element. In order to simplify breaking the device into two separate parts, each of the parts can have a length in the axial direction that is at least 30% of the overall length of the product in the activated state.

According to a preferred aspect, the shape of the second chamber is adapted to the outer shape of the activation element. In particular, the second chamber can have a shape similar to a bullet for a gun and the activation element can also have an outer shape similar to a bullet for a gun.

According to one aspect, the second chamber is formed by a separate container. This can simplify the filling of the first chamber with a first substance since a space or passage disposed for the separate container can provide an opening for filling the first chamber. After filling the first chamber, the first chamber can be sealed by a separation element connected to the housing. Alternatively, the first chamber can be sealed by the separate container, e.g. by a separation element that forms a front side, i.e. a face, of the container.

The separate container can be attachable or attached to the housing. According to an aspect, the separate container is attached to the housing by a snap-fit engagement. Alternatively or additionally, the separate container can be attached to the housing by using corresponding threads. Further, the separate container can be attached to the housing by a bayonet connection. Alternatively or additionally, the separate container can be attached to the housing by a snap-on connection. These connection mechanisms have been found to be best suited for connecting the separate container to the housing and allow attaching the separate container to the housing, e.g. during manufacturing or use, without having to use tools. Preferably, the connection mechanism provides feedback to the user when the separate container is in the activated position. This feedback can be auditory, e.g. by a clicking sound caused by the connection mechanism and/or a haptic feedback, e.g. by a one element of the connection mechanism snapping into another element of the connection mechanism.

Preferably, the separate container is non-removably attachable or attached to the housing. In other words, the separate container, if attached to the housing, cannot be detached from the housing without substantial effort. This reduces the risk of a user wrongfully detaching the separate container before or after activation of the device.

According to one aspect, the housing forms a passage for at least partly receiving the separate container. The separate container can be axially guided by the passage during attachment of the container and/or activation of the device. Preferably, an inner circumferential surface of the passage essentially corresponds to an outer circumferential surface of the separate container so that the inner circumferential surface of the passage guides the separate container during attachment and/or activation. The separate container can be axially guided by the passage towards the activation element. In particular, the passage can be configured to at least almost fully receive the separate container in an activated state. The housing can define an end stop corresponding to an end stop of the separate container. The end stops can abut each other in the activated state. This can be advantageous in providing feedback to the user whether the separate container has been fully moved along the passage to activate the device. In a non-activated state, the separate container is partly arranged in the passage and partly protrudes from the housing. The housing is preferably configured to be placed on a surface via a support surface so that the longitudinal axis of the device is arranged perpendicular to the support surface. In other words, the housing forms a support surface that is arranged perpendicular to the longitudinal axis of the device. An axial force can be applied to an upper front face of the separate container by a user to move the separate container relative to the housing to create a breakthrough in the separation element. The separate container is preferably arranged in the passage in a non-activated state such that the separate container is secured against a bending force acting on the separate container in order to make sure that the separate container does not detach from the housing during activation.

According to an aspect, a sealing structure is formed between an inner circumferential surface of the housing and an outer circumferential surface of the separate container. The sealing structure can comprise at least one first sealing lip or sealing elevation that extends around an inner circumferential surface of the housing. Preferably, the sealing structure comprises at least two first sealing lips or sealing elevations that extend around an inner circumferential surface of the housing. The sealing structure can also comprise at least one second sealing lip or sealing elevation that extends around an outer circumferential surface of the separate container. In a non-activated state, the at least one first sealing lip and the second sealing lip can cause an axial fixation between the separate container and the housing by the at least one first sealing lip and the second sealing lip overlapping each other seen from an axial direction. Preferably, the sealing structure is deactivatable by intentionally pushing the separate container relative to the housing from the non-activated state to the activated state. In particular, the at least one first sealing lip and the at least one second sealing lip are formed so that by moving the separate container relative to the housing, the sealing lips can slide past each other by elastically deforming the first sealing lip, the second sealing lip, the housing and/or the separate container. The first sealing lip or sealing lips can be integrally formed with the housing. The second sealing lip or sealing lips can be integrally formed with the container. This simplifies assembly of the device.

According to an aspect, a venting gap can be formed between an inner circumferential surface of the housing and an outer circumferential surface of the separate container. The venting gap allows air to exit the passage while the separate container is moved axially along the passage towards its activated position. The venting gap preferably is a channel extending in an axial direction from an end region of the passage to a second end region of the passage. The venting gap can be formed in the inner circumferential surface of the housing and/or the outer circumferential surface of the separate container.

According to an aspect, the second chamber is sealed by the separation element in a non-activated state. The separation element can be attached to the separate container. In particular, the separation element can form a front face of the separate container. The front face of the separate container can face towards the activation element. The second chamber can be sealed by the separation element against environmental influences such as humidity and dust.

According to an aspect, the predetermined breaking area is breakable by kinking the housing. “Breakable” means that the connection is breakable by a user by using a usual force used to accidently kink a predetermined breaking area.

According to an aspect, the predetermined breaking area is visible from the outside. In other words, a user holding the device can see the predetermined breaking area from looking at the product. This allows the user to better understand how to break the device into two parts, e.g. by kinking, at the predetermined breaking area.

According to an aspect, the activation element extends in an axial direction and forms at least one spike or sharp edge at a distal end of the activation element. In particular, the activation element can have a length in the axial direction that is considerably larger than its width. This enables the activation element to pierce the separation element more easily by moving the separate container with the separation element in the axial direction relative to the activation element.

The activation element can extend in an axial direction and can form two spikes or sharp edges at the same distal end of the activation element. The two spikes or two sharp edges can be separated by an opening that connects the first chamber and the second chamber in the activated state. The opening can comprise a slot that separates the at least two spikes or sharp edges.

The activation element can be arranged between the first chamber and the second chamber. The activation element can define at least one opening so that, in an activated state, the second component can flow through the opening past the activation element into the first chamber. The activation element can comprise one or more webs extending from an inner circumferential surface of the passage towards a spike portion of the activation element. Multiple openings can be defined between the webs.

According to an aspect, the opening comprises a channel extending inside of the activation element through a majority of the activation element. The opening can extend from the at least one spike or sharp edge to an opposite axial end of the activation element.

According to an aspect, the activation element is firmly connected to the housing. In particular, the activation element and the housing can be manufactured as one piece, e.g. by injection molding.

According to an aspect, the activation element has a circular shaped cross section or an X-shaped cross section. Both versions can have a spike in an end region of the activation element. An activation element with such a cross section is rigid regarding bending so that less material can be used to manufacture the activation element.

According to an aspect, the activation element has a shape similar to a bullet for a gun. The activation element can have a first, cylindrical section and a second, tapered section. The first and the second section can form at least a majority of the outer circumferential surface of the activation element.

The housing can have a bottom portion. The bottom portion can also be called a cap. The bottom portion preferably forms a lower front face or front surface of the housing. The bottom portion can be connected to the remaining housing via a snap fit connection. Alternatively or additionally, the bottom portion can be connected to the remaining housing via ultrasonic welding.

The housing can define a third chamber. The third chamber can at least partially surround the first chamber. In particular, the third chamber completely surrounds the first chamber in the circumferential direction.

According to an embodiment, the housing forms exactly one outlet for withdrawing a mixture of the first component and the second component in an activated state. This allows to withdraw the mixture in a controlled manner.

The disclosure also relates to a method of mixing a first component with a second component, comprising providing a device with a housing forming a first chamber for the first component, a second chamber for the second component, a separation element for separating the first chamber and the second chamber, and an activation element integrally formed with the housing for creating a breakthrough through the separation element, wherein a predetermined breaking area is formed in the housing, further comprising creating a breakthrough through the separation element so that the first component and the second component mix, creating an outlet for withdrawing a mixture of the first component and the second component by breaking the housing at the predetermined breaking area.

According to an aspect, the second chamber is formed by a separate container, and the method further comprises: moving the separate container relative to the housing thereby creating the breakthrough through the separation element. The moving of the separate container relative to the housing can comprise moving the separate container linearly relative to the housing.

According to an aspect, the breaking of the housing at the predetermined breaking area comprises kinking the housing. Due to the leverage effect, breaking of the housing by kinking can be more comfortable than e.g. breaking of the housing by torsion.

The first component can be a powder and the second component can be a liquid. Alternatively, the first component can be a liquid and the second component can be a powder. According to another option, the first component and the second component can be both liquids.

According to an aspect, the first chamber and the second chamber are arranged on top of each other during the mixing of the first component with the second component. This allows the two components to mix only by gravitational force acting on the above arranged component causing it to fall down and mix with the below arranged component.

According to a further aspect, the method further comprises removing a first part of the device including the second chamber from the rest of the device to create the outlet for withdrawing the mixture of the first component and the second component.

### BRIEF DESCRIPTION OF THE DRAWINGS

The disclosure will be described in more detail with reference to the drawings.

FIG. 1 illustrates a front view of a device according to a first embodiment of the disclosure;

FIG. 2 illustrates a sectional view of the device of FIG. 1 along line A-A of FIG. 1;

FIG. 3A illustrates a detailed view of an activation element shown in FIG. 2;

FIG. 3B illustrates a top view of the device of FIG. 1;

FIG. 4 illustrates a front view of a device according to a second embodiment of the disclosure;

FIG. 5 illustrates a sectional view of the device of FIG. 4 along line A-A of FIG. 4;

FIG. 6A illustrates a detailed view of an activation element shown in FIG. 5;

FIG. 6B illustrates a top view of the device of FIG. 4;

FIG. 7 illustrates a front view of a device according to a third embodiment of the disclosure;

FIG. 8 a sectional view of the device of FIG. 7 along line A-A of FIG. 7;

FIG. 9A a detailed view of a sealing structure shown in FIG. 8;

FIG. 9B a detailed view of sealing lips of the sealing structure shown in FIG. 9A;

FIG. 10A a detailed view of an activation element shown in FIG. 8; and

FIG. 10B a top view of the device of FIG. 8.

### DETAILED DESCRIPTION

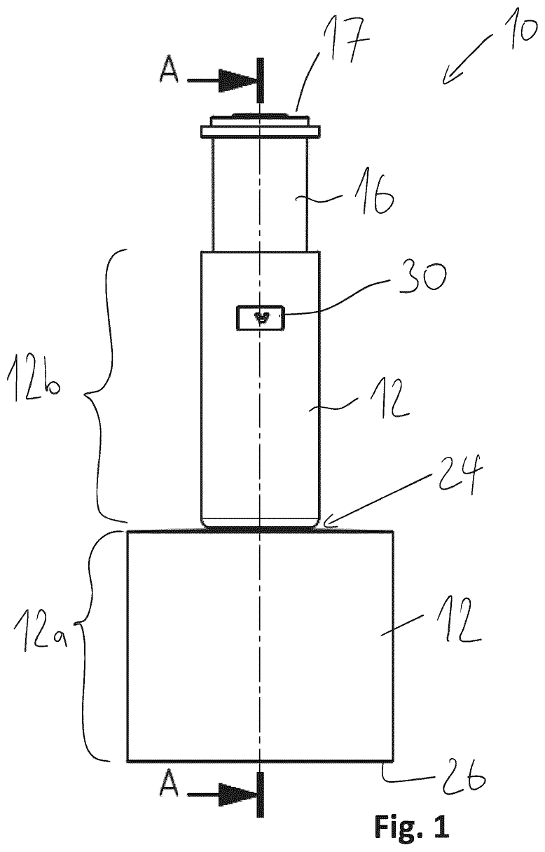

FIGS. 1 to 4 depict a device 10 according to a first embodiment for mixing a first component 15 being arranged in a first chamber 14 with a second component 19 being arranged in a second chamber 18.

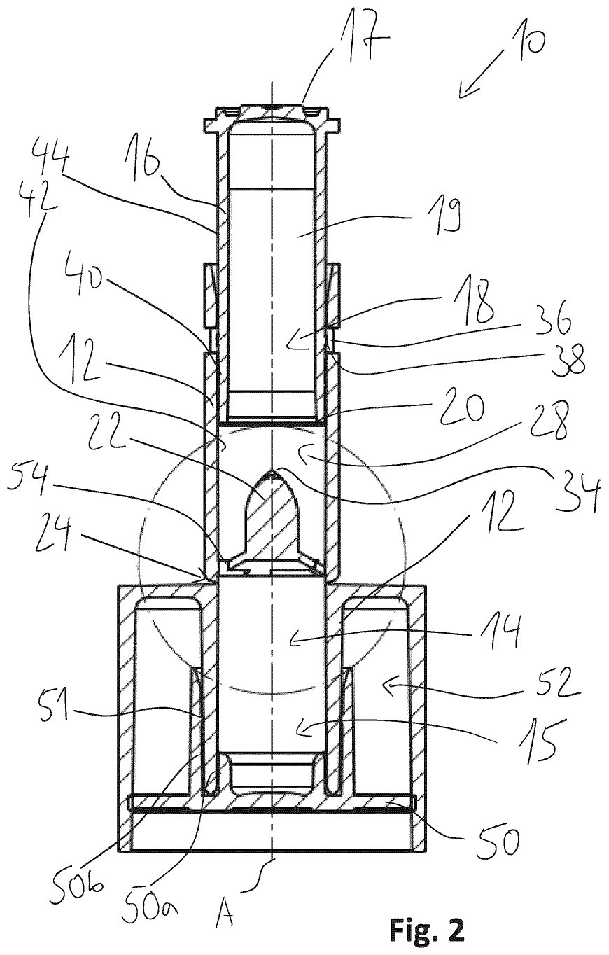

As is apparent from FIGS. 1 and 2, the device 10 has a housing 12 with a first axial section 12a having a larger cross section and a second axial section 12b having a smaller cross section on top of the first axial section 12a. On the border between the first axial section 12a and the second axial section 12b, a predetermined breaking area 24 in the form of a tapered section is formed. The tapered section has a smaller cross-section than the smaller second axial section 12b.

In the shown non-activated state, a separate container 16 protrudes out of a top end of the second axial section 12b of the housing 12 along a longitudinal axis A of the device 10. The device 10 comprises a support surface 26 on the lower face of the first axial section 12a on which the device 10 can be placed in order to conveniently activate the device 10. The support surface 26 is defined by the housing 12. The separate container 16 forms an activation surface 17 on the upper face of the separate container 16. In order to activate the device 10, a user pushes onto the activation surface 17 causing the separate container 16 to move axially relative to the housing 12 towards the support surface 26. An indication means (device) 30 in the form of a window in the second axial section 12b of the housing 12 through which a marking on the separate container 16 depicting a direction of movement which the container 16 should do in order to activate the device 10 can be seen.

FIG. 2 depicts a longitudinal sectional view of the device 10 in the non-activated state. The housing 12 defines the first chamber 14 which can be at least partly filled with the first component 15. The first chamber 14 is arranged in the first axial section 12a of the housing 12. The separate container 16 defines the second chamber 18 which can be at least partly filled with the second component 19. At a lower front face of the separate container 16, the second chamber 18 is sealed by a separation element 20. The separate container 16 is arranged inside a passage 28 defined by an inner circumferential surface 42 of the second axial section 12b of the housing 12. The separate container 16 has an outer circumferential surface 44 corresponding to the inner circumferential surface 42 of the second axial section 12b of the housing 12. This allows the separate container 16 to slide along the inner circumferential surface 42 of the housing 12 when the user pushes onto the activation surface 17. In order to allow air to move out of the passage 28 into the surroundings while the separate container 16 is pushed downwardly, a venting gap 40 can be formed between the inner circumferential surface 42 of the housing 12 and the outer circumferential surface 44 of the separate container 16. In order to define axial positions of the separate container 16 relative to the housing 12, i.e. a non-activated position corresponding to an axial position in the non-activated state and/or an activated position corresponding to an axial position in the activated state, a corresponding engagement means (device) 36, 38 are formed on the inner circumferential surface 42 of the housing 12 and the outer circumferential surface 44 of the separate container 16. The corresponding engagement means 36, 38 can e.g. form a snap-fit connection that is non-releasable if the separate container 16 is moved away from the first chamber 14 but is releasable if the separate container 16 is moved towards the first chamber 14. This makes sure that the user does not accidentally pull the separate container 16 out of the passage 28.

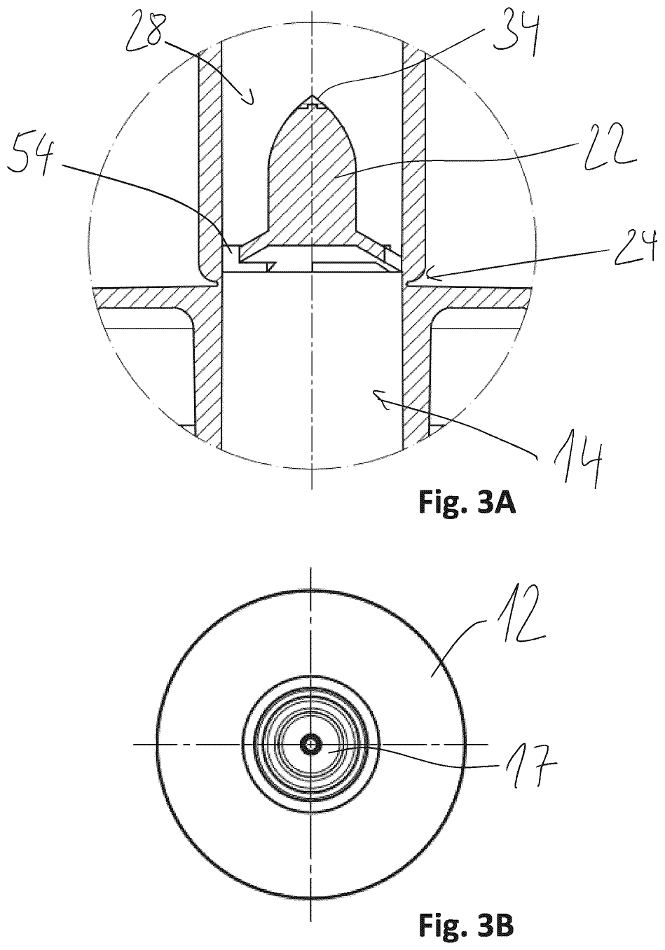

An activation element 22 is arranged between the first chamber 14 and the second chamber 18 in the second axial section 12b of the housing 12. The activation element 22 is formed integrally with the housing 12. As can be seen from FIG. 3, the activation element 22 extends along the longitudinal axis A and forms a spike 34 on the upper end facing the separation element 20 forming the lower front face of the separate container 16. When the separate container 16 is pushed downwards, the spike 34 is configured to create a breakthrough through the separation element 20. When the breakthrough is created in the separation element 20, i.e. in the activated state, the second component 19 can pass the separation element 20. Due to gravitational force acting on the second component 20, the second component moves past the broken separation element 20. The activation element 22 forms at least one opening 54 to connect the passage 28 with the first chamber 14. Through said opening 54, the second component 20 can fall into the first chamber 14 to mix with the first component 15.

A bottom portion 50 forming a lower front face of the device 10 is formed by a different part than the housing 12. This bottom portion 50 is connected to the housing 12 via a snap fit connection 51. In order to seal the connecting region between the housing 12 and the bottom portion 50, the bottom portion 50 comprises an outer circumferential surface 50a which is in surface contact with an inner circumferential surface of the part of the housing 12 defining the first chamber 14 and an inner circumferential surface 50b which is in surface contact with an outer circumferential surface of the part of the housing 12 defining the first chamber 14. The housing further defines a third chamber 52 extending circumferentially around the first chamber 14. The third chamber 52, like the first chamber 14, is closed at its lower end by the bottom portion 50.

In the activated state, the first component 15 and the second component 19 are arranged in the first chamber 14. In order to withdraw the mixture, an opening has to be created. This opening is created by kinking the housing 12 so that the housing breaks into two parts at the predetermined breaking area 24 (not shown).

As can be seen in FIG. 3B, the housing 12 as well as the separate container 16 have a circular cross-section so that the device 10 can be easily held in both hands for kinking the housing 12 into two parts.

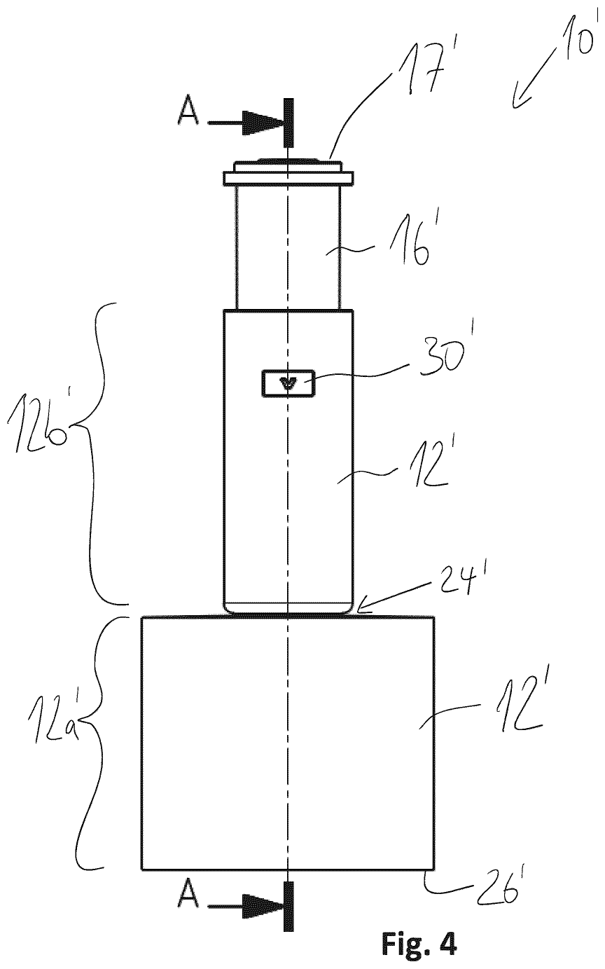

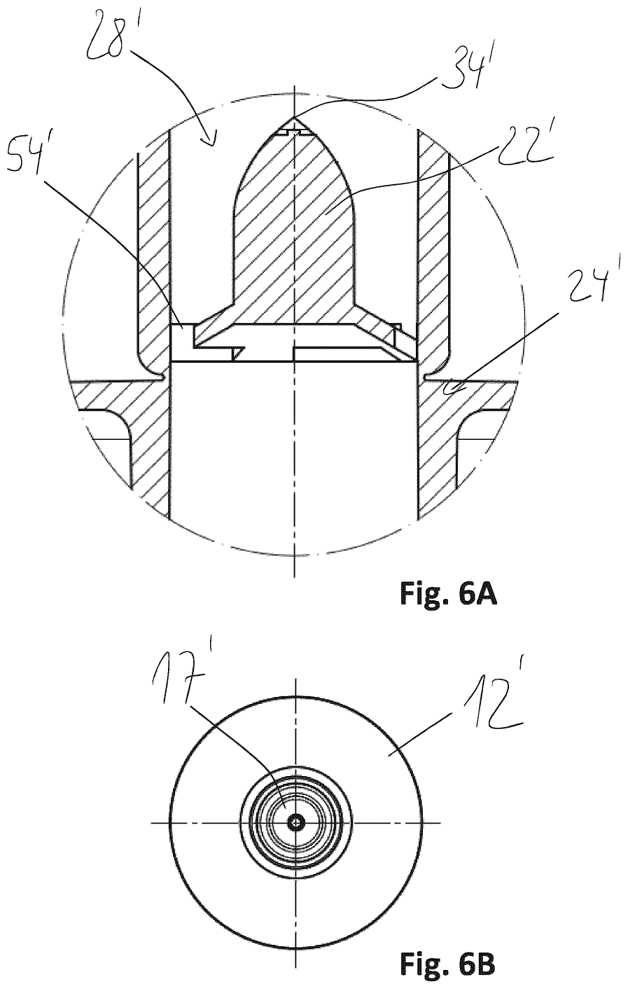

FIGS. 4 to 6B depict a slightly different embodiment of a device 10′ according to the disclosure. Instead of the bottom portion 50 being connected to the housing 12 by a snap-fit engagement 51, the bottom portion 50′ is connected to the housing 12 via ultrasonic welding. This improves the sealing between the bottom portion 50′ and the housing 12 so that only a smaller surface connection is needed between the bottom portion 50′ and the part of the housing 12 defining the first chamber 14.

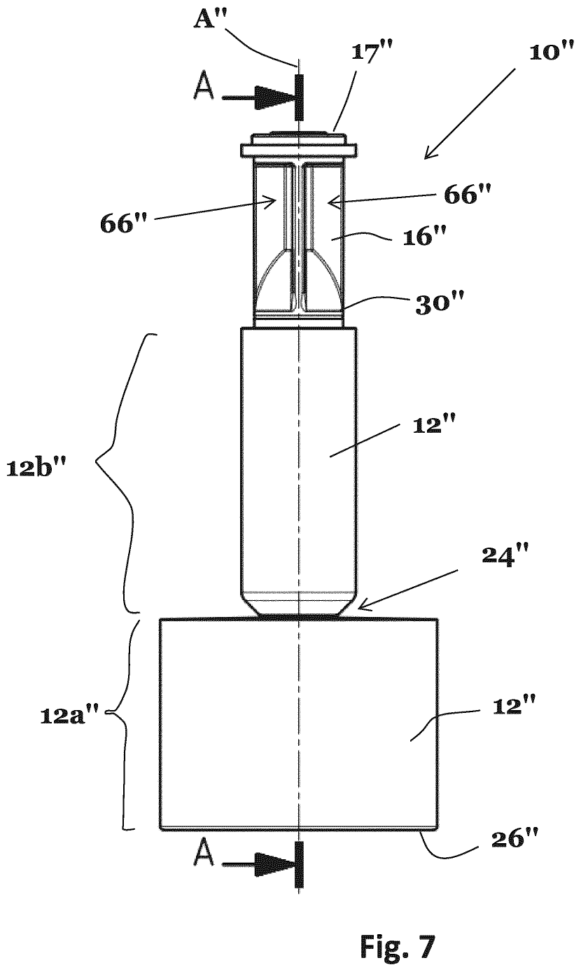

FIGS. 7 to 10B depict a device 10″ according to a further embodiment of the disclosure. Same or similar features of the embodiments are marked with corresponding reference signs.

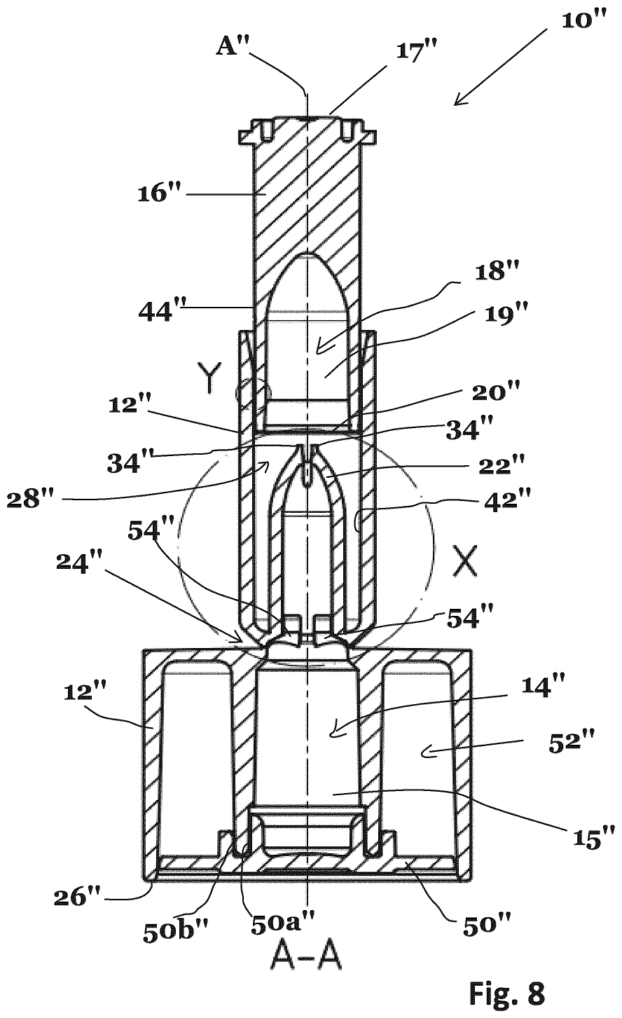

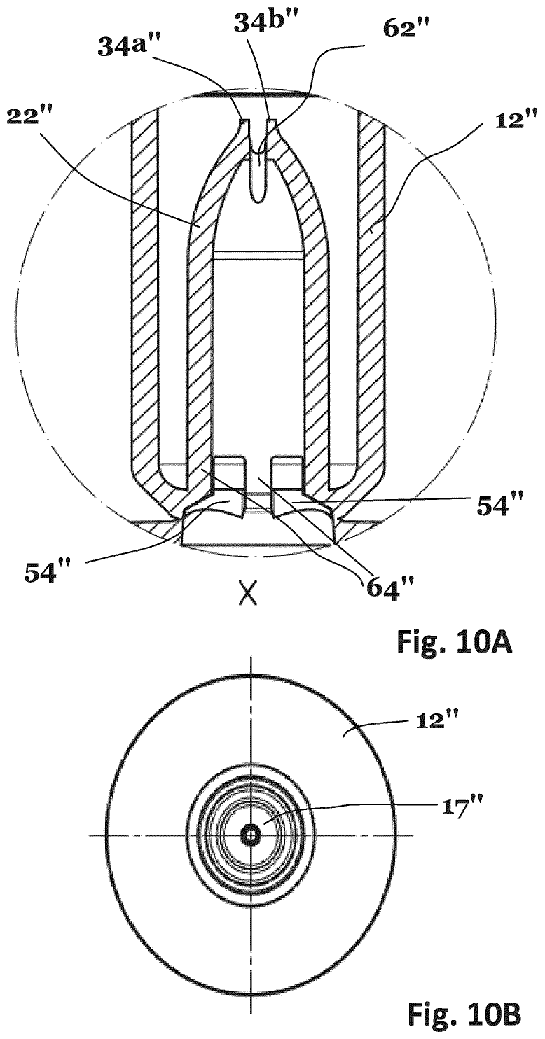

As can be seen from FIG. 8 and FIG. 10A, the activation element 22″ has an outer shape similar to a bullet for a gun. At the axial end facing the separation element 20″, two sharp edges 34a″ and 34b″ are formed. These sharp edges 34a″ and 34b″ are configured to form a puncture in the separation element 20″ so that a second component 19″ being stored in the second chamber 18″ formed by the container 16″ can exit that second chamber 18″. An opening 62″ is formed between the sharp edges 34a″ and 34b″ and extends through the separation element 20″ along the longitudinal axis A″ of the device 10″. The opening 62″ allows the second component 19″ to flow through the separation element 20″ into a first chamber 14″ that is partially filled with a first component 15″. As can also be seen in FIG. 10A, openings 54″ are formed at a bottom of the separation element 20″ to connect a space outside of the separation element 20″ to the second chamber 14″. The openings 54″ are defined by ribs 64″ that integrally connect a housing 12″ of the device 10″ with the activation element 22″.

As can be best seen in FIG. 8, the second chamber 18″ has a shape that is adapted to the outer shape of the activation element 22″. In other words, the second chamber 18″ has a shape that corresponds to the bullet-like shape of the activation element 22″. In order to safe material and reduce weight, cutouts 66″ are formed in the outer circumferential surface of the separate container 16″.

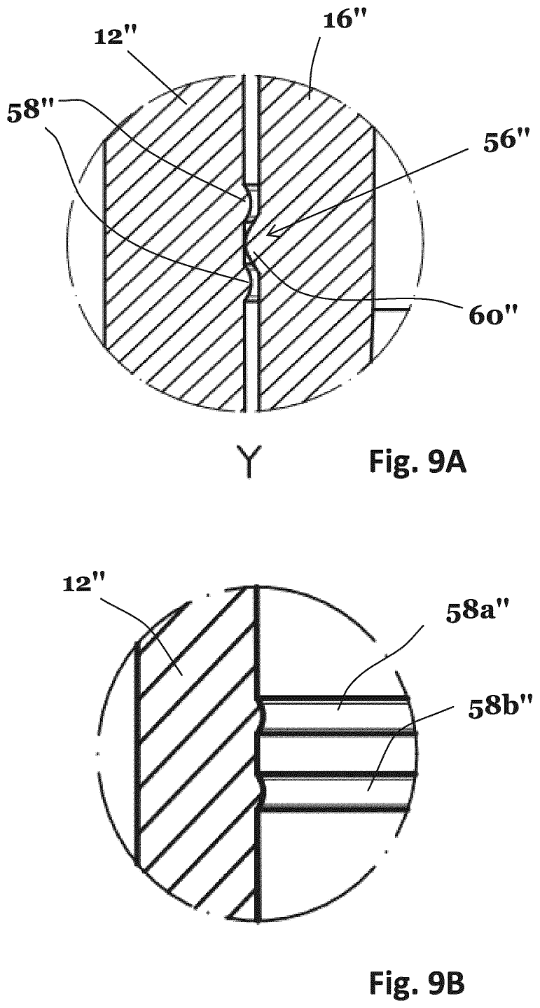

FIG. 9A shows a detailed view of section Y shown in FIG. 8 between the outer circumferential surface of the container 16″ and the inner circumferential surface 42″ of the housing 12″. FIG. 9A generally shows a sealing structure 56″ between the outer circumferential surface 44″ of the container 16″ and the inner circumferential surface of the housing 12″. Said sealing structure 56″ is active in the non-activated state of the device 10″. The sealing structure 56″ comprises two first sealing lips 58a″ and 58b″ (see FIG. 9B) that each extend along the inner circumferential surface 42″ of the housing 12″ in a direction perpendicular to the longitudinal axis A″. The sealing structure 56″ further comprises a second sealing lip 60″ formed on the outer circumferential surface 44″ of the container 16″. In the non-activated state shown in FIGS. 8 and 9A, the two first sealing lips 58″ and the second sealing lip 60″ cause an axial fixation between the separate container 16″ and the housing 12″ by the second sealing lip 60″ extending into a space between the two first sealing lips 58″. In other words, the two first sealing lips 58″ and the second sealing lip 60″ overlap each other seen from an axial direction so that a temporary form-fitting connection is established between the container 16″ and the housing 12″.

For activating the device 10″, the container 16″ is moved along the inner circumferential surface 42″ of the housing 12″ towards the activation element 22″. Thereby, the form-fitting connection between the container 16″ and the housing 12″ is dissolved by the second lip 60″ sliding over the first lip 58b″. This is possible because of an elastic deformation of the first lip 58b″, the second lip 60″, the housing 12″ and/or the container 16″. However, a significant force of the user is need to dissolve the form-fitting connection. The sealing structure 56″ therefore has two main functions: The container 16″ is safely attached in the housing 12″ so that the container 16″ cannot fall out of the housing 12″ and cannot accidently move towards the activation element 22″ and secondly, a first resistance is created when the container 16″ is pushed by the user towards the activation element 22″. This will help to obtain more precise and repeatable activation, as a minimal “activation speed” will be reached.

Instead of the indications means 30 being shown in a window of the housing 12 as is shown in FIG. 1, the indication means 30″ (see FIG. 7) can be formed by a mark 30″ on the outer circumferential surface 44″ of the container 16″ that is visible from the outside when the device 10″ is in the non-activated state but is hidden behind the housing 12″ in the activated state. The mark can comprise a groove extending around the outer circumferential surface 44″ of the container 16″ perpendicular to the longitudinal axis A″.

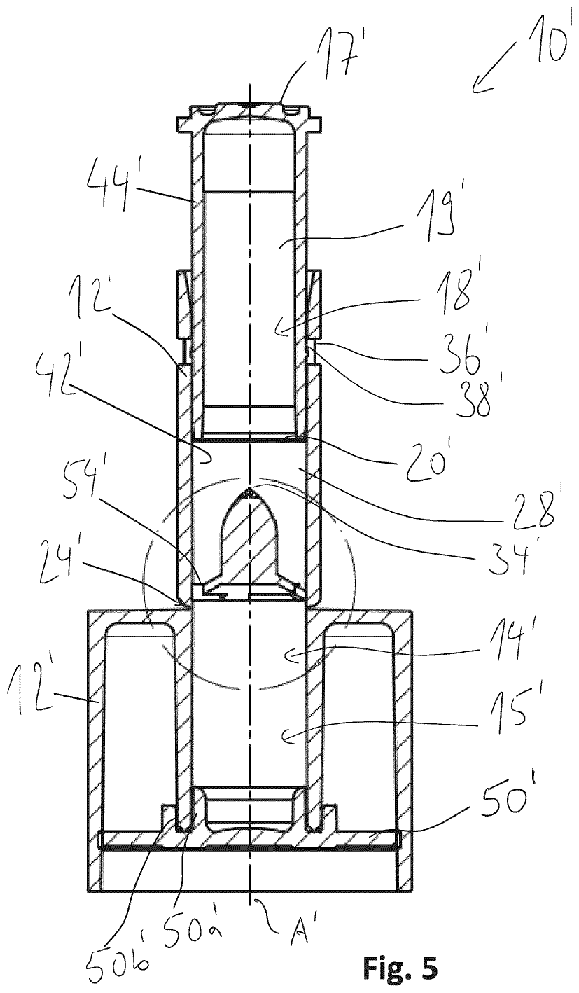

In the embodiment shown in FIG. 8, the bottom portion 50″ is attached to the housing 12″ via ultrasonic welding, like the bottom 50′ shown in FIG. 5.

1. A device for mixing a first component with a second component, comprising
a housing forming a first chamber for the first component, a second chamber for the second component, and a separation element separating the first chamber and the second chamber;
an activation element configured to create a breakthrough through the separation element, the activation element integrally formed with the housing; and
a predetermined breaking area formed in the housing to create an outlet to withdraw a mixture of the first component and the second component.

2. The device according to claim 1,
wherein the predetermined breaking area extends around at least a majority of a circumference of the housing.

3. The device according to claim 1,
wherein the predetermined breaking area is arranged so that the device is intentionally breakable into two parts.

4. The device according to claim 1,
wherein the second chamber is formed by a separate container attachable or attached to a remainder of the housing.

5. The device according to claim 4,
wherein the housing forms a passage for at least partly receiving the separate container.

6. The device according to claim 4,
wherein the separation element is attached to the separate container, or
a sealing structure is formed between an inner circumferential surface of the housing and an outer circumferential surface of the separate container, or
a venting gap is formed between the inner circumferential surface of the housing and the outer circumferential surface of the separate container.

7. The device according to claim 1,
wherein the second chamber is sealed by the separation element in a non-activated state against environmental influences.

8. The device according to claim 1,
wherein the predetermined breaking area is breakable by kinking the housing, or the predetermined breaking area is visible from outside, or
the activation element extends in an axial direction and forms a spike or a sharp edge.

9. The device according to claim 1,
wherein the activation element is arranged between the first chamber and the second chamber and defines an opening so that in an activated state the second component is capable of flowing through the opening past the activation element into the first chamber.

10. The device according to claim 1,
wherein the activation element is firmly connected to the housing, or
the activation element has a circular shaped cross section, or
the activation element has a shape of a bullet.

11. The device according to claim 1,
wherein the housing has a bottom portion, and
the bottom portion is connected to a remaining portion of the housing via ultrasonic welding, or
the bottom portion is connected to the remaining portion of the housing via a snap fit connection.

12. The device according to claim 1, w
herein the housing defines a third chamber, and
the third chamber at least partially surrounds the first chamber.

13. A method of mixing a first component with a second component, the method comprising:
providing a device with a housing forming a first chamber for the first component, a second chamber for the second component, and a separation element separating the first chamber and the second chamber, and an activation element integrally formed with the housing for creating a breakthrough through the separation element, a predetermined breaking area formed in the housing;
creating the breakthrough through the separation element so that the first component and the second component mix; and
creating an outlet to withdraw a mixture of the first component and the second component by breaking the housing at the predetermined breaking area.

14. The method according to claim 13,
wherein the second chamber is formed by a separate container, and the method further comprises
moving the separate container relative to the housing to create the breakthrough through the separation element.

15. The method according to claim 13,
wherein breaking the housing at the predetermined breaking area comprises kinking the housing, or
the first component is a powder and the second component is a liquid or the first component is a liquid and the second component is a powder, or the first component is a liquid and the second component is a liquid, or
the first chamber and the second chamber are arranged on top of each other during mixing of the first component with the second component, or
the method further comprises removing a first part of the device including the second chamber from a remainder of the device to create the outlet for withdrawing the mixture of the first component and the second component.

16. The device according to claim 1,
wherein the predetermined breaking area is arranged so that the device is intentionally breakable into a first part and a second part, the first part forming the first chamber and the second part forming the second chamber and the activation element.

17. The device according to claim 4,
wherein the housing forms a passage for at least partly receiving the separate container, and the separate container is axially guided by the passage during attachment of the container or activation of the device.

18. The device according to claim 1,
wherein the activation element forms a first spike or a sharp edge and a second spike or sharp edge, the first spike or a sharp edge and the second spike or sharp edge being separated by an opening connecting the first chamber and the second chamber in an activated state, at a distal end of the activation element.

19. The device according to claim 9,
wherein the activation element comprises a web extending from an inner circumferential surface towards a spike portion of the activation element and multiple openings are defined between the web, or
the opening of the activation element comprises a channel extending inside of the activation element through a majority of the activation element.

20. The method according to claim 14,
wherein moving the separate container relative to the housing comprises moving the separate container linearly relative to the housing.
